(19) United States
(12) Patent Application Publication
(10) Pub. No.: US 2025/0314592 A1
(43) Pub. Date: Oct. 9, 2025

(54) RESONATOR-ENHANCED GAS SENSORS, SYSTEMS, AND METHODS

(71) Applicant: Washington University, St. Louis, MO (US)

(72) Inventors: Guangming ZHAO, St. Louis, MO (US); Jie LIAO, St. Louis, MO (US); Yihang LI, St. Louis, MO (US); Wenbo MAO, St. Louis, MO (US); Qian ZHANG, St. Louis, MO (US); Fu LI, St. Louis, MO (US); Lan YANG, St. Louis, MO (US)

(21) Appl. No.: 19/170,496

(22) Filed: Apr. 4, 2025

Related U.S. Application Data
(60) Provisional application No. 63/574,959, filed on Apr. 5, 2024.

(51) Int. Cl. G01N 21/77

(52) U.S. Cl. CPC G01N 21/7746; G01N 2021/7796; G01N 2201/06113

(57) ABSTRACT

A gas sensing system includes a packaged photonic sensor including a resonant sensor and a control system. The control system includes a light module, a receiver module, and a core module. The light module includes a light source to generate light and transmit it to the photonic sensor. The receiver module receives light signals from the photonic sensor and converts them to digital signals. The core module includes a computing device and is programed to: control the light module to cause the light module to generate and transmit light to the packaged photonic sensor, receive the digital signals from the receiver module, and detect one or both of a concentration of a gas that interacted with the resonant sensor and an identification of the gas whose molecules interacted with the resonant sensor based at least in part on the received digital signals from the receiver module.

### CROSS REFERENCE TO RELATED APPLICATIONS

This application claims priority to U.S. Provisional Patent Application No. 63/574,959, filed Apr. 5, 2024, which is hereby incorporated herein by reference in its entirety.

### BACKGROUND

The field relates generally to gas sensors and more particularly to resonator-enhanced gas sensors, systems, and methods.

Gas sensing plays a critical role in numerous applications, from environmental monitoring to medical diagnosis and ensuring safety in workplace and food industries. For example, effective and precise sensors are indispensable in places like mines and gas pipelines where methane could accumulate, safeguarding human lives, infrastructure, and the environment. Gas sensing is valuable for both fundamental research, such as atmospheric science and biomechanical analysis, and for industrial applications, such as pipeline leakage monitoring. Versatile gas sensors with high sensitivity and general selectivity are desired for applications ranging from atmospheric science and the Internet of Things (IoT) to homeland security and public health.

Historically, electrical gas sensors have been demonstrated by pellistors, semiconductors, metal-oxides (MOX), electrochemical materials, and nanomaterials, such as carbon nanotubes and graphene, etc. Although these electrical gas sensors typically possess high sensitivity, down to the ppm or ppb level, they cannot effectively distinguish different gases, i.e., they lack selectivity. As an alternative, optical gas sensors are the gold standard for measuring the absorption spectra and distinguishing different gases. Optical absorption spectrometers provide fairly high sensitivity and selectivity, but their laser-based mechanism is inherently bulky, costly, and delicate.

This background section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### BRIEF SUMMARY

One aspect of this disclosure is a gas sensing system including a packaged photonic sensor including a resonant sensor and a control system coupled to the packaged photonic sensor. The control system includes a light module, a receiver module, and a core module. The light module includes a light source to generate light and transmit the generated light to the packaged photonic sensor. The receiver module receives light signals from the packaged photonic sensor and converts the received signals to digital signals. The core module includes a computing device and is coupled to the light module and the receiver module. The core module is programed to: control the light module to cause the light module to generate and transmit light to the packaged photonic sensor, receive the digital signals from the receiver module, and detect one or both of a concentration of a gas that interacted with the resonant sensor and an identification of the gas whose molecules interacted with the resonant sensor based at least in part on the received digital signals from the receiver module.

According to another aspect of this disclosure, a packaged photonic sensor for detecting a gas of interest in a gas sensing system includes a whispering gallery mode (WGM) resonator, a coupling waveguide positioned proximate the WGM resonator, and a polymer that is affected by interaction with molecules of the gas of interest.

Another aspect of this disclosure is a method of sensing gas. The method includes generating laser light and transmitting the laser light to a resonant sensor exposed to one or more gasses, directing the laser light from the resonant sensor to a photodetector to create digital signals, directing the digital signals from the photodetector to a computing device, and detecting, by the computing device, one or both of a concentration of a gas in the one or more gasses whose molecules interacted with the resonant sensor and an identification of a gas in the one or more gasses whose molecules interacted with the resonant sensor based at least in part on the digital signals from photodetector.

Various refinements exist of the features noted in relation to the above-mentioned aspects. Further features may also be incorporated in the above- mentioned aspects. These refinements and additional features may exist individually or in any combination. For instance, various features discussed below in relation to any of the illustrated embodiments may be incorporated into any of the above-described aspects, alone or in any combination.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The following figures illustrate various aspects of the disclosure.

FIG. 1 is an image of a optical-resonator-based sensor in accordance with one aspect of the disclosure.

FIG. 2A is a cross-sectional schematic view of the optical-resonator-based sensor shown in FIG. 1, in which the optical-resonator-based sensor is embedded within a low-index polymer material.

FIG. 2B is a schematic side view of the embedded optical-resonator-based sensor of FIG. 2A.

FIG. 3 is a block diagram schematically illustrating an example system in accordance with one embodiment of the disclosure.

FIG. 4 illustrates an example component configuration of a computing device according to one embodiment of the disclosure.

FIG. 5 illustrates an example configuration of a remote or user computing device according to one embodiment of the disclosure.

FIG. 6 illustrates an example configuration of a server system according to one embodiment of the disclosure.

FIG. 7 is a diagram of an example gas sensing system 700 according to the present disclosure.

FIG. 8 is a graph of light transmission to and from an example resonant sensor of the present disclosure, showing a resonant wavelength shift and mode linewidth broadening caused by a gas interacting with the resonant sensor.

FIG. 9 is graphically present the sensing mechanism of packaged resonator gas sensor of the present disclosure based on resonance shift and linewidth broadening;

FIG. 10 is a COMSOL simulation of the mode profile in a simulated packaged microtoroidal sensor.

FIG. 11 is a COMSOL simulation of the mode profile in a simulated unpackaged WGM resonator surrounded by air.

FIG. 12 is a graph of measured wavelength shift as a function of time when detecting different concentrations of 2-octanone with an example packaged WGM gas sensor.

FIG. 13 is a graph of measured wavelength shift as a function of time when detecting different concentrations of acetone with the example packaged WGM gas sensor.

FIG. 14 is a graph of measured wavelength shift as a function of time when detecting different concentrations of hexanol with the example packaged WGM gas sensor.

FIG. 15 is a graph of measured wavelength shift as a function of concentration (in ppm) for the three gasses tested in FIGS. 12-14 using the example packaged WGM gas sensors.

FIG. 16. is a schematic diagram of an example multi-laser sequential probing gas sensing system.

FIG. 17 is a schematic diagram of an example multi-laser simultaneous probing gas sensing system.

Corresponding reference characters indicate corresponding parts throughout the drawings.

### DETAILED DESCRIPTION

The present disclosure relates generally to gas sensors and more particularly to resonator-enhanced gas sensors, systems, and methods. The example gas sensors described herein are based on micro-resonators generally, and in some embodiments are based on whispering gallery mode (WGM) micro-resonators more specifically. Aspects of this disclosure will primarily be described with respect to WGM micro-resonators, but they are not so limited and may be applied to other related sensors, including ring resonators and race-track resonators. Micro-resonators and WGM micro-resonators will be discussed generally before the specifics of the gas sensors based on such resonators. It should be understood that the micro-resonators and WGM micro-resonators described herein are example and any other suitable resonator may be used in the sensors, systems, and methods described herein.

Additional details of micro-resonators and WGM micro-resonators may be found in U.S. Pat. Nos. 9,012,830, 10,782,289, and U.S. Patent Application Publication No. 2024/0426641, the entire contents of which are incorporated herein by reference in their entireties.

With a unique capability to confine light in small volumes with ultra-low loss, the gas sensing systems of the present disclosure intensify light-matter interactions, enabling high sensitivity and resolution. Their compactness, coupled with real-time functionality across varied environments, empowers them to discern even trace gas amounts. Keys to their operation include detectable frequency shifts, indicating changes in the refractive index, and changes in resonance linewidth and baseline intensity, revealing optical absorption characteristics. These shifts and changes provide a comprehensive insight into the medium's chemical composition. Optical micro-resonator-based sensors of this disclosure overcome at least some of the limitations of some known gas sensors, providing both high sensitivity and selectivity within a robust sub-millimeter-size fiber-based device.

Resonator-based micro/nano-optical resonator sensors typically rely on either resonance frequency shift or mode splitting due to changes in the effective polarizability of the resonator system upon particle binding. Optical devices fundamentally rely upon interactions between light and the matter being detected. The more increase in light to matter interaction new phenomena can be detected because of higher resolution and as a result new functionalities of these sensors can be developed. For micro-resonators interactions increase because light circulates in a resonator multiple times with minimal loss.

Photonic technologies on one hand have brought about new concepts in materials and devices such as photonic crystals and meta materials, and, on the other hand, brought about the realization and testing of century-old well known theories such as quantum theory, plasmonics and whispering galleries which have been enjoying many benefits of recent developments in enabling technologies and fabrication techniques. Since its first explanation in acoustic regime by Lord Rayleigh in London's St Paul's Cathedral, Whispering Gallery Mode (WGM) phenomenon has been explored in various optical structures for a variety of applications, opening unprecedented and unforeseen directions in optical sciences.

Resonator-based sensors have shown to detect and count individual nanoparticles having a radius as small as radius 30 nanometers (nm). This high sensitivity is attributed to the resonance-enhanced interaction between the particle and the evanescent tail of the light field due to tight light confinement and extended interaction time provided by the resonator. These sensors generally require a fiber taper to couple the light into and out of the resonator from a tunable laser, whose wavelength is continuously scanned to monitor the changes in the resonance modes, thus making these highly compact and sensitive sensors relatively expensive.

An optical cavity, also called an optical resonator, is an arrangement of mirrors that forms a standing wave cavity resonator for light waves. Optical cavities are a major component of lasers, surrounding the gain medium and providing feedback of the laser light. Light confined in the cavity reflects multiple times producing standing waves for certain resonant frequencies. The standing wave patterns produced are called “modes”. Longitudinal modes differ only in frequency while transverse modes differ for different frequencies and have different intensity patterns across the cross-section of the beam. Constructive or destructive interference between multiple reflections between two or more reflecting surfaces can occur. Resonance Condition 2 nL=mλ.

To understand how optical ring resonators work, one must first understand the optical path length difference (OPD) of a ring resonator. This is given as follows for a single-ring ring resonator:

$$OPD = 2 π {rn}_{eff} \qquad ( 1 )$$

where r is the radius of the ring resonator and n_{eff} is the effective index of refraction of the waveguide material. Due to the total internal reflection requirement, n_{eff} must be greater than the index of refraction of the surrounding fluid in which the resonator is placed (e.g. air). For resonance to take place, the following resonant condition must be satisfied:

$$OPD = m {λ}_{m} \qquad ( 2 )$$

where λₘ is the resonant wavelength and m is the mode number of the ring resonator. This equation means that in order for light to interfere constructively inside the ring resonator, the circumference of the ring must be an integer multiple of the wavelength of the light. As such, the mode number must be a positive integer for resonance to take place. As a result, when the incident light contains multiple wavelengths (such as white light), only the resonant wavelengths will be able to pass through the ring resonator fully.

The quality factor of an optical resonator can be quantitatively described using the following formula:

$$Quality Factor : Q = 2 π \frac{stored energy}{energy lost per cycle} \qquad ( 3 )$$

The quality factor is useful in determining the spectral range of the resonance condition for any given ring resonator. The quality factor is also useful for quantifying the amount of losses in the resonator as a low Q factor is usually due to large losses

WGM resonators (WGMRs) are a type of optical cavity resonator but they do not have mirrors (i.e., mirror-less cavities). WGMRs can support two counter-propagating modes at the same resonance frequencies. Unless these counter-propagating modes are coupled strongly to each other (for example by scattering via defect centers, scatterers or structural inhomogeneity's), the wave inside a WGMR is a travelling wave. When the counter propagating modes are coupled to each other, they form a standing wave mode. Interaction strength in a micro-resonator is a function of the spectral Quality Factor (Q) and Spatial Volume (V), which will define the energy density within the cavity. It is desirable to have a high Q, while maintaining a smaller mode volume V.

Whispering-gallery waves, (i.e. whispering-gallery modes), are a type of wave that can travel around a concave surface. Whispering-gallery waves exist for light and sound waves. While they propagate light and sound waves (i.e., any type of waves), they form patterns called modes. Optical whispering-gallery-modes have been produced in microscopic glass spheres, micro-disks, micro-toroid, micro-bottle, etc. . . . structures, for example, with applications in lasing and sensing. In such structures, the light waves are almost perfectly guided by optical total internal reflection, leading to Q factors in excess of 10¹⁰ being achieved. WGMRs resonate, i.e. have a tendency to oscillate with greater amplitude at some frequencies more so than at others, at certain frequencies. Frequencies at which the response amplitude is a relative maximum are known as the system's resonant frequencies, or resonance frequencies. At these frequencies, even small periodic driving forces can produce large amplitude oscillations, because the system stores energy.

WGM micro-resonators with their high quality factor, Q, and small mode volume, V, are known to enhance light-matter interactions and have extraordinary sensitivities to changes and perturbations in their structure or proximity. They have been of great interest for sensing biomarkers, DNA, and medium-size proteins at low concentrations, as well as for detecting viruses and nanoparticles at single-particle resolution. A particle or molecule entering the mode volume of a resonator or binding onto its surface induces a net change in the polarizability of the resonator-surrounding system and perturbs its optical properties. This manifests itself as a shift of the resonance frequency, broadening of the resonance linewidth, or formation of a doublet via mode splitting depending on the interaction strength and the scattering and absorption properties of the binding particle or the molecule.

In WGM sensors, the fundamental limit of sensitivity is determined by Q/V, which quantifies the strength of the interaction between the particle and the cavity field. Thus, it can be improved by decreasing V or increasing Q. One can increase Q by compensating for the losses and decrease V by shrinking the size of the WGM resonator (WGMR). However, decreasing the resonator size below a critical value inevitably increases bending losses and eventually decreases Q. Instead, hybrid systems combining high-Q WGMs with highly confined (small-V) localized plasmons have been demonstrated, achieving detection of single proteins and very small viruses. Q enhancement of WGM resonances by compensating losses via optical gain has also been demonstrated in silica micro-toroids doped with rare-earth ions such as erbium (Er3+) and ytterbium (Yb3+). Resonators with optical gain are referred to as active resonators.

Recent advances in fabrication techniques and material sciences have helped to achieve Whispering Gallery Mode Resonators (WGMRs) with ultra-high-quality (Q) factors and nano/micro-scale mode volumes (V), which in turn have enabled novel applications and devices such as ultra-low threshold on-chip micro-lasers, narrowband filters and modulators for optical communication, high performance optical sensors achieving label free detection at single-particle resolution, cavity opto-mechanics, and quantum electrodynamics. The Q factor or quality factor is a dimensionless parameter that describes how under-damped an oscillator or resonator is, or equivalently, characterizes a resonator's bandwidth relative to its center frequency. Higher [symbol] indicates a lower rate of energy loss relative to the stored energy of the oscillator, i.e., the oscillations die out more slowly. When such a WGMR is optically pumped above lasing threshold, the resultant laser has a narrower linewidth than the cold cavity and thereby improves the detection limit and sensitivity beyond what can be achieved by the passive (no optical gain-providing mechanism) or by the active resonator below the lasing threshold.

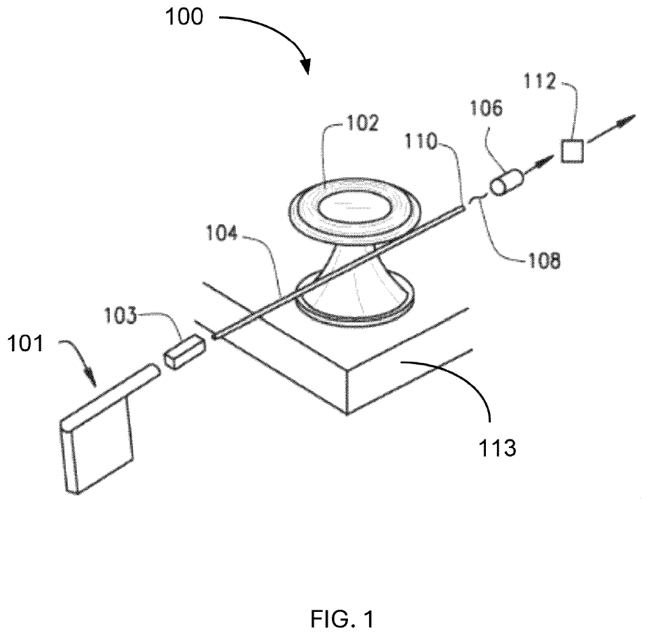

FIG. 1 is an illustration of an example optical micro-resonator sensor system 100 that may be used as (or as part of) a gas sensor system in embodiments of the present disclosure. The system 100 can include a light source 101 including, but not limited to a tunable laser. The system 100 further includes a WGM resonator 102 attached to a substrate 113, and a coupling waveguide 104 to bring the laser energy in and out of the resonance modes of the resonator 102. In the example embodiment, the WGM resonator 102 is a microtoroid resonator. The WGM resonator 102 is not limited to a microtoroid resonator and other embodiments may use different types of resonators. The system 100 may further include an optic coupler 103 configured to direct the laser energy produced by the light source 101 into the coupling waveguide 104. Non-limiting examples of suitable light sources include semiconductor lasers (DFB or FP laser diodes), GaN or similar LED on-chip light sources, or on-chip WGM microlasers whose wavelength can be finely tuned by temperature control or by controlling the driving current. A photoreceiver 106 (or a photodetector) coupled to an opposite end of the coupling waveguide 104 can be used to detect the laser signal 108 at the output port 110 of the coupling waveguide 104.

The WGM resonator 102 may be coated, encapsulated in a matrix, or both. In the example embodiment, the coating and/or matrix is chosen to be responsive to specific chemicals to enhance the sensitivity (e.g., how low a concentration of a particular gas may be detected) and enable selectivity (e.g., the ability to distinguish between different gasses). For example, the matrix and/or coating could be a polymer capable of expanding upon exposure to methane; therefore, the response of the resonator sensor could be enhanced by the expansion of the polymer that is coated outside the resonator sensor. When a reference resonator (e.g., a WGM resonator 102 not coated with the same polymer) is also included, the system could achieve selective sensing based on the distinctive response of the polymer layer to methane.

In some embodiments, both the light source 101 and the photoreceiver 106 are linked to a computing device 112. The computing device is configured to control the operation of the light source 112 and to process the output from the photoreceiver 106 to extract information related to light transmission from the resonator 102. The computing device 112 of the system 100 include a processor and a non-volatile computer-readable memory.

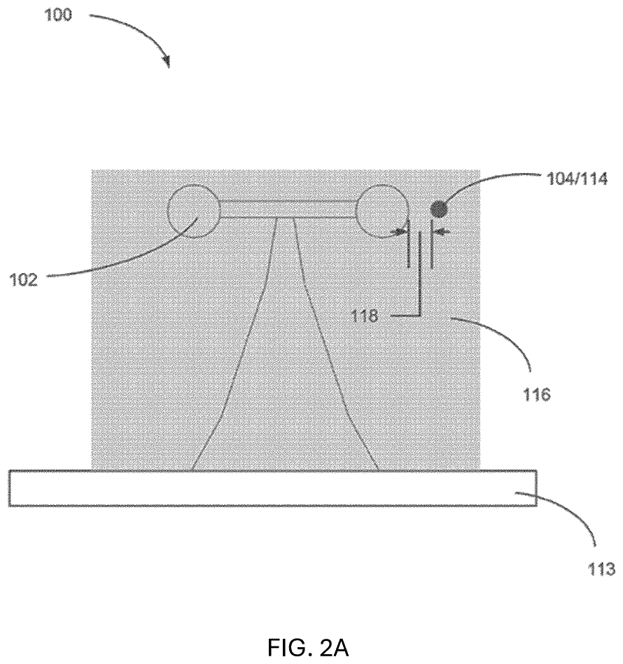

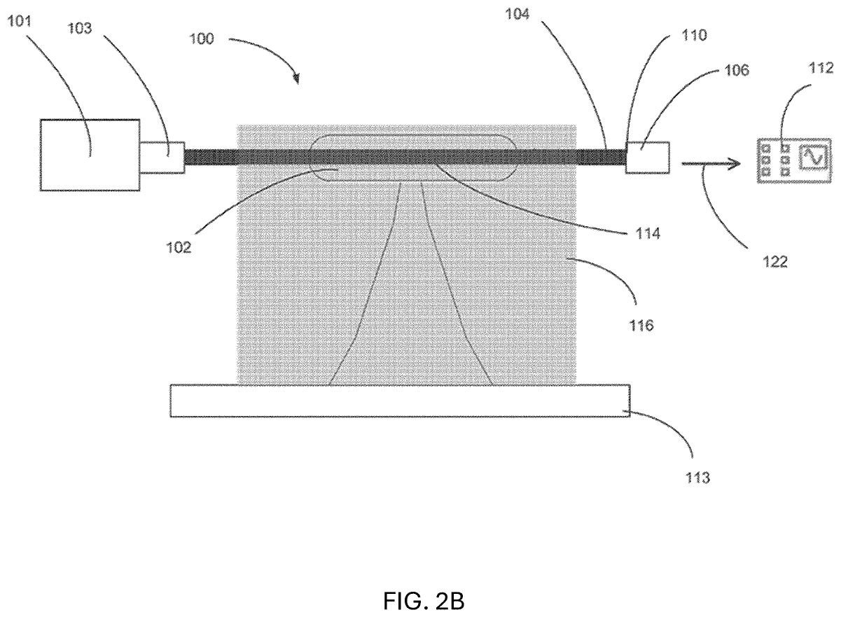

FIGS. 2A and 2B are cross-sectional and side schematic views, respectively, of a system 100 similar to the system illustrated in FIG. 1, in which the WGM resonator 102 and a portion 114 of the coupling waveguide 104 are encased in a polymer 116. In one embodiment, the polymer 116 maintains the portion 114 of the coupling waveguide 104 and the WGM resonator 102 in a fixed arrangement. In some embodiments, the fixed arrangement may include a gap 118 separating the coupling waveguide 104 from the WGM resonator 102.

In various embodiments, the selected value of the gap is influenced by any one or more of a plurality of factors including, but not limited to, dimensions and materials of the optical WGM resonator, dimensions and materials of the coupling waveguide, dimensions and materials of the encapsulating polymer, the operational parameters of the optical WGM oscillator-based pressure sensor, and any other relevant factor.

In some embodiments, the polymer 116 is applied in an uncured state over the WGM resonator 102, the coupling waveguide 104, and the substrate 113 and is subsequently cured in situ using a curing method. Any known curing method may be used to cure the low-index polymer 116 without limitation, as long as the curing method is compatible with the selected polymer material. Non-limiting examples of suitable curing methods include UV curing, moisture curing, and cross-link curing. In some embodiments, the degree of curing may be varied to modulate the acoustic impedance and/or refractive index of the polymer 116 to levels that enable the efficient operation of the system 100.

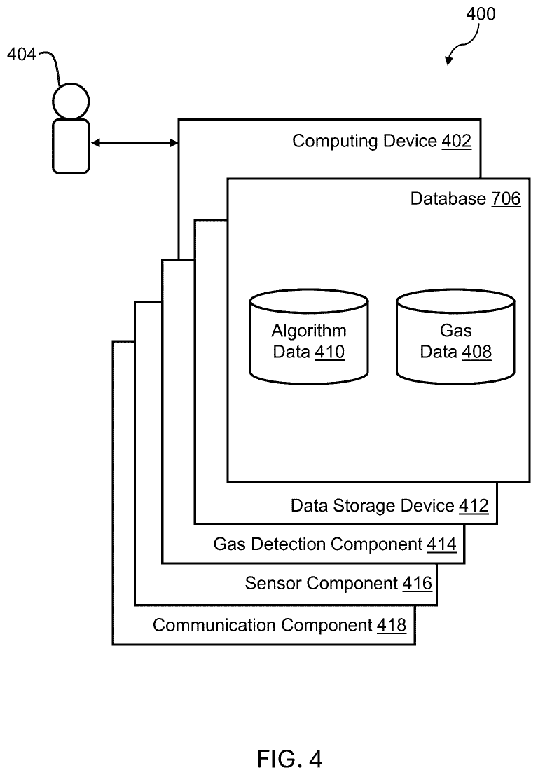

FIG. 2B is a side view of the system 100 illustrated in FIG. 4A. As illustrated in FIG. 2B, the ends of the coupling waveguide 104 adjacent to the encased portion 114 project from the low-index polymer encasement 116 to enable the coupling of the light source 101 to the coupling waveguide 104 via the optic coupler 103 and to enable the coupling of the coupling waveguide 104 to the photodetector 106. The photodetector 106 is configured to detect a laser signal output at an output port 110 of the coupling waveguide 104 and to transmit a detector output signal 122 representative of the detected laser signal output.

In various embodiments, the optical resonator may be characterized by a diameter ranging from about 50 μm to about 200 μm in various other embodiments, the diameter of the resonator ranges from about 50 μm to about 60 μm, from about 55 μm to about 65 μm, from about 60 μm to about 70 μm, from about 65 μm to about 75 μm, from about 70 μm to about 80 μm, from about 75 μm to about 85 μm, from about 80 μm to about 90 μm, from about 85 μm to about 95 μm, from about 90 μm to about 100 μm, from about 95 μm to about 105 μm, from about 100 μm to about 120 μm, from about 110 μm to about 130 μm, from about 120 μm to about 140 μm, from about 130 μm to about 150 μm, from about 140 μm to about 160 μm, from about 150 μm to about 170 μm, from about 160 μm to about 180 μm, from about 170 μm to about 190 μm, and from about 180 μm to about 200 μm.

Without being limited to any particular theory, the diameter of the optical resonator may influence at least one of a plurality of factors related to the performance of the sensor including, but not limited to: resonant wavelengths and center frequencies of the sensor.

In various embodiments, the coupling waveguide may comprise any suitable waveguide without limitation. In some embodiments, the coupling waveguide is a tapered fiber. The minimum diameter of the tapered fiber may range from about 0.5 μm to about 5 μm. In various other embodiments, the minimum diameter of the tapered fiber ranges from about 0.5 μm to about 0.7 μm, from about 0.6 μm to about 0.8 μm, from about 0.7 μm to about 0.9 μm, from about 0.8 μm to about 1.0 μm, from about 0.9 μm to about 1.1 μm, from about 1 μm to about 2 μm, from about 1.5 μm to about 2.5 μm, from about 2 μm to about 3 μm, from about 2.5 μm to about 3.5 μm, from about 3 μm to about 4 μm, from about 3.5 μm to about 4.5 μm, and from about 4 μm to about 5 μm. Without being limited to any particular theory, smaller taper diameters are thought to optimize the coupling of shorter light wavelengths onto the WGM resonators of the disclosed sensors as described herein. The coupling waveguides may be constructed of any suitable materials known in the art including, but not limited to, a fused silica material, a low-loss optical polymer, and any other suitable material.

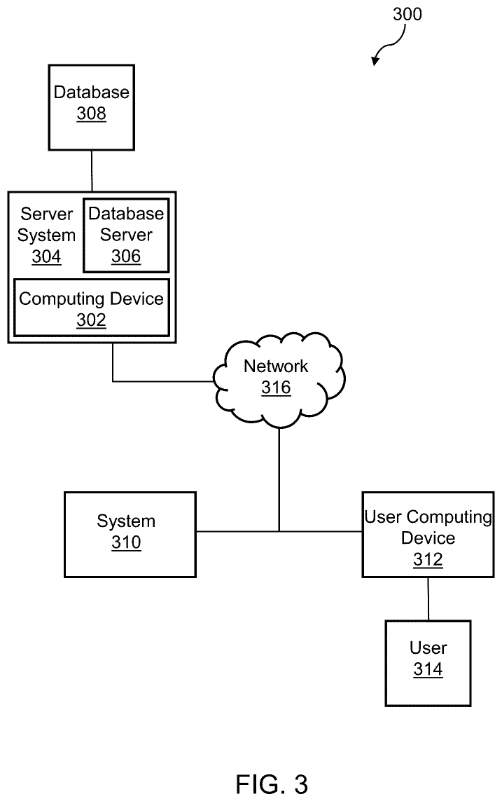

FIG. 3 is a block diagram schematically illustrating a system in accordance with one embodiment of the disclosure. FIG. 3 illustrates a simplified block diagram of a computing system 300 for implementing the methods described herein. As illustrated in FIG. 3, the computing system 300 may be configured to implement at least a portion of the tasks associated with disclosed method using the disclosed resonator-based sensors (e.g., for gas sensing). Computer system 300 may include a computing device 302. In one embodiment, the computing device 302 is part of a server system 304, which also includes a database server 306. Computing device 302 is in communication with a database 308 through database server 306. Computing device 302 is communicably coupled to system 310 (e.g., a gas sensing system) and a user computing device 312 of a user 314 through a network 316. Network 316 may be any network that allows local area or wide area communication between the devices. For example, network 316 may allow communicative coupling to the Internet through at least one of many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. User computing device 312 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In other embodiments, computing device 302 is configured to perform a plurality of tasks associated with the operation of a resonator-based sensor and/or a system incorporating the resonator-based sensors including, but not limited to the systems described herein.

FIG. 4 depicts a component configuration 400 of a computing device 402 associated with a user 404. Device 402 includes database 406 along with other related computing components. In some embodiments, computing device 402 is similar to computing device 302 (shown in FIG. 3). User 404 may access components of computing device 402. In some embodiments, database 406 is similar to database 308 (shown in FIG. 3).

In one embodiment, database 406 includes gas data 408 and algorithm data 410. Non-limiting examples of suitable gas data 408 may include wavelength shifts associated with different concentrations of gas, resonant line shape changes associated with particular gasses, and the like. Non-limiting examples of suitable algorithm data 410 include any values of parameters defining the operation of the WGM resonator-based sensors, and gas sensing systems. Additional non-limiting examples of suitable algorithm data 410 includes any algorithms and any values of parameters defining the algorithms associated with the disclosed method as described herein.

Computing device 402 also includes a number of components that perform specific tasks. In the example embodiment, computing device 402 includes data storage device 412, gas detection component 414, sensor component 416, and communication component 418. Data storage device 412 is configured to store data received or generated by computing device 402, such as any of the data stored in database 406 or any outputs of processes implemented by any component of computing device 402.

Communication component 418 is configured to enable communications between computing device 402 and other devices (e.g., user computing device 312 and system 310, shown in FIG. 3) over a network, such as network 316 (shown in FIG. 3), or a plurality of network connections using predefined network protocols such as TCP/IP (Transmission Control Protocol/Internet Protocol).

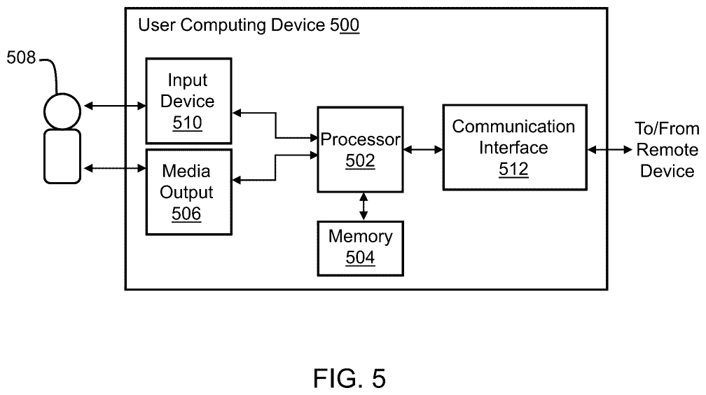

FIG. 5 depicts a configuration of a remote or user computing device 500, such as user computing device 312 (shown in FIG. 5). Computing device 500 may include a processor 502 for executing computer-readable/-executable instructions. In some embodiments, executable instructions may be stored in a memory area of memory 504. Processor 502 may include one or more processing units (e.g., in a multi-core configuration). Memory 504 may be any device allowing information such as executable instructions and/or other data to be stored and retrieved. Memory 504 may include one or more computer-readable media (e.g., hard drive, RAM, ROM, and the like).

Computing device 500 may also include at least one media output component 506 for presenting information to a user 508. Media output component 506 may be any component capable of conveying information to a user 508. In some embodiments, media output component 506 may include an output adapter, such as a video adapter and/or an audio adapter. An output adapter may be operatively coupled to processor 502 and operatively coupled to an output device such as a display device (e.g., a liquid crystal display (LCD), organic light emitting diode (OLED) display, cathode ray tube (CRT), or “electronic ink” display) or an audio output device (e.g., a speaker or headphones). In some embodiments, media output component 506 may be configured to present an interactive user interface (e.g., a web browser or client application) to user 508.

In some embodiments, computing device 500 may include an input device 510 for receiving input from user 508. Input device 510 may include, for example, a keyboard, a pointing device, a mouse, a stylus, a touch sensitive panel (e.g., a touch pad or a touch screen), a camera, a gyroscope, an accelerometer, a position detector, and/or an audio input device. A single component such as a touch screen may function as both an output device of media output component 506 and input device 510.

Computing device 500 may also include a communication interface 512, which may be communicatively coupled to a remote device. Communication interface 512 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory 504 are, for example, computer-readable/-executable instructions for providing a user interface to user 508 via media output component 506 and, optionally, receiving and processing input from input device 510. A user interface may include, among other possibilities, a web browser and client application. Web browsers enable users 508 to display and interact with media and other information typically embedded on a web page or a website from a web server. A client application allows users 508 to interact with a server application associated with, for example, a vendor or business.

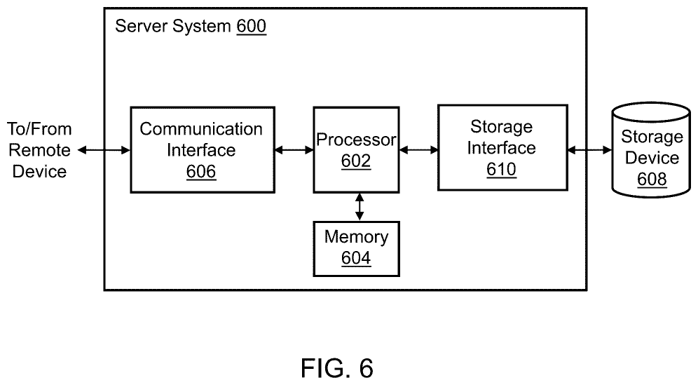

FIG. 6 illustrates an example configuration of a server system 600. Server system 600 may include, but is not limited to, database server 306 and computing device 302 (both shown in FIG. 3). In some embodiments, server system 600 is similar to server system 304 (shown in FIG. 3). Server system 600 may include a processor 602 for executing instructions. Instructions may be stored in a memory area of memory 604, for example. Processor 602 may include one or more processing units (e.g., in a multi-core configuration).

Processor 602 may be operatively coupled to a communication interface 606 such that server system 600 may be capable of communicating with a remote device such as user computing device 312 (shown in FIG. 3) or another server system 600. For example, communication interface 606 may receive requests from user computing device 312 via a network 316 (shown in FIG. 3).

Processor 602 may also be operatively coupled to a storage device 608. Storage device 608 may be any computer-operated hardware suitable for storing and/or retrieving data. In some embodiments, storage device 608 may be integrated in server system 600. For example, server system 600 may include one or more hard disk drives as storage device 608. In other aspects, storage device 608 may be external to server system 600 and may be accessed by a plurality of server systems 600. For example, storage device 608 may include multiple storage units such as hard disks or solid-state disks in a redundant array of inexpensive disks (RAID) configuration. Storage device 608 may include a storage area network (SAN) and/or a network attached storage (NAS) system.

In some embodiments, processor 602 may be operatively coupled to storage device 608 via a storage interface 610. Storage interface 610 may be any component capable of providing processor 602 with access to storage device 608. Storage interface 610 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 602 with access to storage device 608.

Memory 504 (shown in FIG. 5) and 604 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only and are thus not limiting as to the types of memory usable for storage of a computer program.

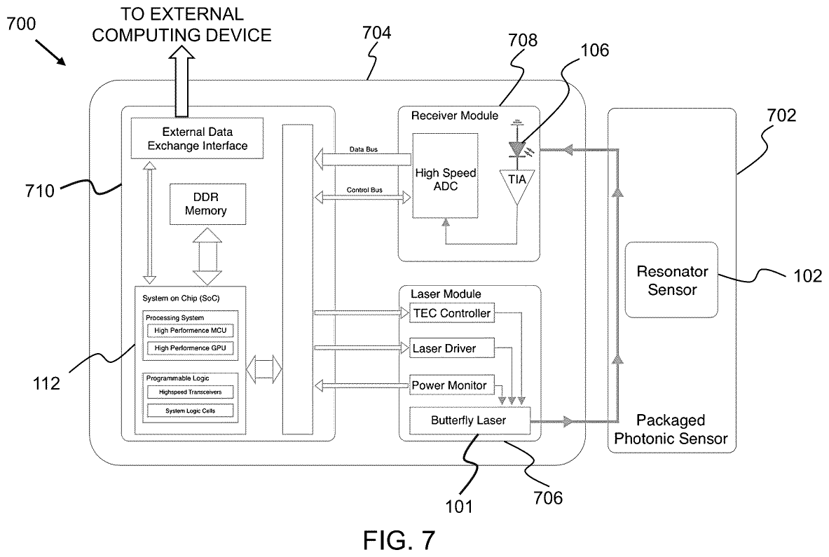

FIG. 7 is a diagram of an example gas sensing system 700 according to the present disclosure. The gas sensing system 700 is designed for system control, high-speed data acquisition, and real-time data analysis. The gas sensing system 700 includes a packaged photonic sensor 702 and a control system 704.

The packaged photonic sensor 702 includes the WGM resonator 102 mounted to a substrate 113, and the coupling waveguide 104 (all shown in FIGS. 1, 2A and 2B). The WGM resonator 102 is coated, encapsulated in a matrix (e.g. in a a low refractive index polymer), or both. The coating/matric is chosen to be responsive to specific chemicals to further enhance the sensitivity and enable the selectivity of the sensor system. For example, it could be a polymer capable of expanding upon exposure to methane; therefore, the response of the resonator sensor could be enhanced by the expansion of the polymer that is coated outside the resonator sensor. When a reference resonator is also included, the system could achieve selective sensing based on the distinctive response of the polymer layer to methane. Different coatings/matrices may be used to achieve the desired sensitivity and selectivity of molecules/gasses of interest. The resonator 102 may be coated in a same or a different material (e.g., a polymer) than the material (e.g., a polymer) encapsulating the resonator. Although only a single WGM resonator 102 is shown and described, some embodiments include more than one (e.g., an array) WGM resonator 102 in the packaged photonic sensor 702. Moreover, in some embodiments including more than one WGM resonator 102, the resonators 102 may include different resonators (e.g., different types), some may be coated with a different material than others, and/or some resonators 102 may be encapsulated in a different material than others. Further, some embodiments utilize more than one packaged photonic sensor 702, with each packaged photonic sensor 702 including one or more resonator 102.

The control system 704 includes three primary modules: the laser module 706, the receiver module 708, and the core module 710. The laser module 101 generally includes/corresponds to the light source 101, the receiver module 708 generally includes/corresponds to the photoreceiver 106, and the core module generally includes/corresponds to the computing device 112, all as shown in FIG. 1. Similar components will use the same reference numbers and perform similarly except as noted.

The laser module 706 contains a tunable laser to generate probe light for the packaged photonic sensor 702 and is connected to the sensor 702 to provide the probe light. The laser module 706 also includes a Thermo-Electric Cooler (TEC) controller for consistent laser performance, a laser driver to power up and accurately tune the laser wavelength, and a power monitor to provide feedback control to ensure stable laser output.

The receiver module 708 captures the light that has interacted with the gas sample (not shown) through the photonic sensor 702. The photoreceiver 106 converts the received light signal into an electrical signal. In the example embodiment, the photoreceiver 106 is a photo diode. In other embodiments, the photoreceiver is any other suitable device, component, or circuit for converting light signals into electrical signals. A transimpedance amplifier (TIA) is utilized to amplify the relatively weak electrical signal to a measurable level. A high-speed Analog-to-Digital Converter (ADC) digitizes the analog signal, which is then transferred to the core module 710 for data processing.

The core module 720 includes the computing device 112. IN the example embodiment, the computing device 112 is a high-performance field-programmable gate array (FPGA) capable of caching and processing complex datasets. The processor manages the real-time analysis of data, allowing for immediate interpretation of gas compositions. Processed data is transferred to an external computing device software interface (not shown) via the external data exchange interface, providing an accessible platform for users to interact with the data.

The gas sensing system 700 is based on a packaged high-quality (Q) whispering gallery mode (WGM) micro-resonator 102, which combines high concentration sensitivity with gas selectivity provided by absorption spectroscopy. The spectrum signatures of Acetone, 2-octanone, and 2-octanol are detectable at the parts per billion (ppb) level. This versatile gas sensor, with high sensitivity and selectivity, is both portable and usable in distributed networks.

Using a high-quality (Q) resonator 102 in the gas sensing system 700, such as whispering gallery mode (WGM) micro-resonators, ring resonators, or race-track resonators, provide a significant improvement over both electrical and optical gas sensors. The ultra-high buildup factor of WGM and spectrally distributed WGMs provide high refractive index sensitivity for gas concentration sensing and absorption spectrum acquisition for gas selectivity, respectively. The compact device footprint of a hundred-micron-level could fit in a variety of operating environments and is promising for forming sensor arrays.

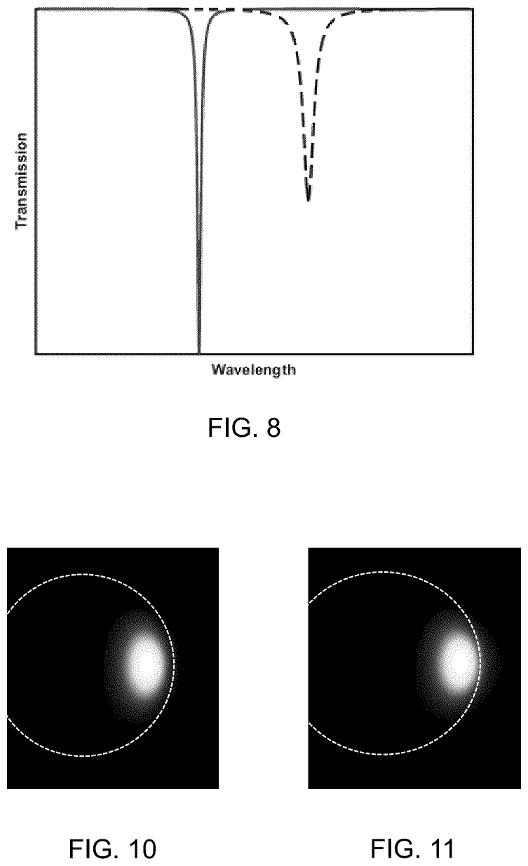

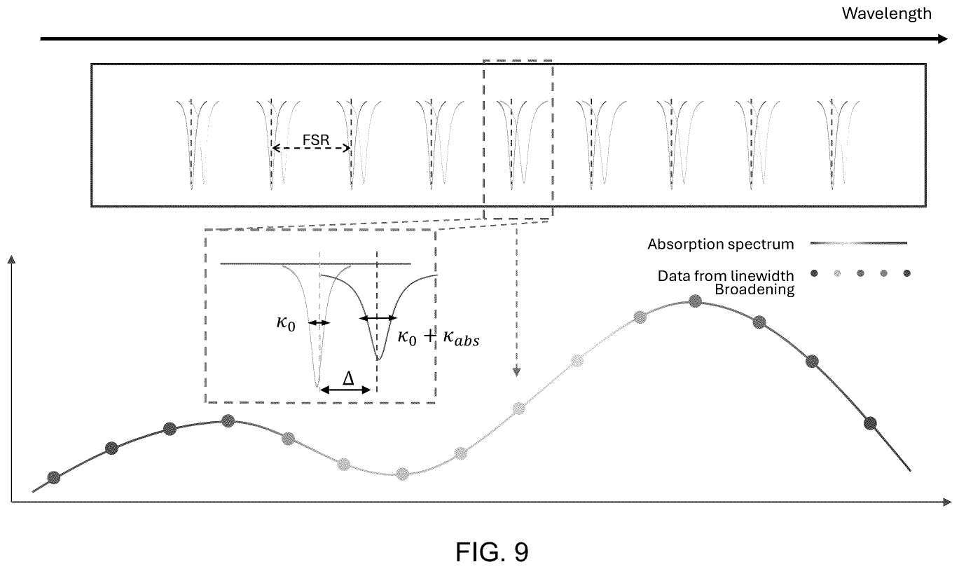

The gas sensing system 700 operates based on the absorption spectrum, combining the high sensitivity of resonator sensors and the selectivity of optical gas sensors. Specifically, it measures the real part of the refractive index of gas at a particular wavelength by the resonant wavelength shift and measures mode linewidth broadening induced by optical absorption as shown in FIG. 8. Concentration information is derived from the mode shift, while selectivity is achieved by measuring a set of linewidth broadening data of different resonant modes which helps to extract absorption spectrum information over a broad wavelength band as shown in FIG. 9. In the example embodiment, the high Q WGM microcavity 102 and its coupler (i.e., a tapered fiber waveguide) 104 are packaged inside a low refractive index polymer 116 (shown in FIGS. 2A and 2B). The packaged polymer swells when exposed to a gas and the resulting refractive index decrease causes a blue shift, from which quantitative information about the target analytes can be derived. Meanwhile, qualitative information about the target gas penetrating the polymer package can be obtained by measuring the mode broadening of a set of WGMs with the same mode family. This configuration provides advantages including: (i) the polymer protects both sensor and taper region but is penetrable by gas samples; (ii) it provides robust surroundings; (iii) the swelling response to gas penetration amplifies the refractive index changes, allowing significantly increased sensitivity. FIG. 10 and FIG. 11 show a COMSOL simulation of the mode profile in a simulated packaged microtoroidal sensor such as the sensor 702 and an unpackaged WGM resonator surrounded by air, respectively. The results show that evanescent field penetrates more deeply into the surroundings for a packaged resonator (FIG. 10) than an unpackaged one (FIG. 11).

A gas sensing system was built and tested based on the teachings above. The tested sensing system and testing results will be described below.

The gas sensing system used silica microtoroid resonators with ultra-high Q factors and small mode volumes. Responding to the target gas sample, the Lorentzian lineshape undergoes a shift and a broadening due to the gas-introduced refractive index change and extra optical loss, respectively. However, bare silica WGM resonators are not suitable for gas sensing because most of the optical resonant fields are confined in silica due to the high index contrast between silica (1.45) and the gas sample (˜1). Thus, the spectral response of WGMs is rather limited. Thus in this example, the high-Q microtoroid was packaged (e.g., encased in) in a moisture curable polymer MY-133 (MY Polymers, Israel), with a refractive index of 1.33 after curing and an optical transparent window covering both visible and NIR. Such a configuration provides advantage including: (i) the polymer package is a protecting layer for both the microtoroid resonator and the optical coupling region while stays penetrable to gas samples; (ii) it provides a moderate index contrast with respect to silica so that the evanescent field could penetrate more deeply into the surroundings comparing with an unpackaged one, as shown in FIGS. 10 and 11; (3) its swelling response to the gas sample amplifies the refractive index change. In this way, the sensitivity was significantly increased.

### Highly Sensitive Gas Sensing by Wavelength Shift

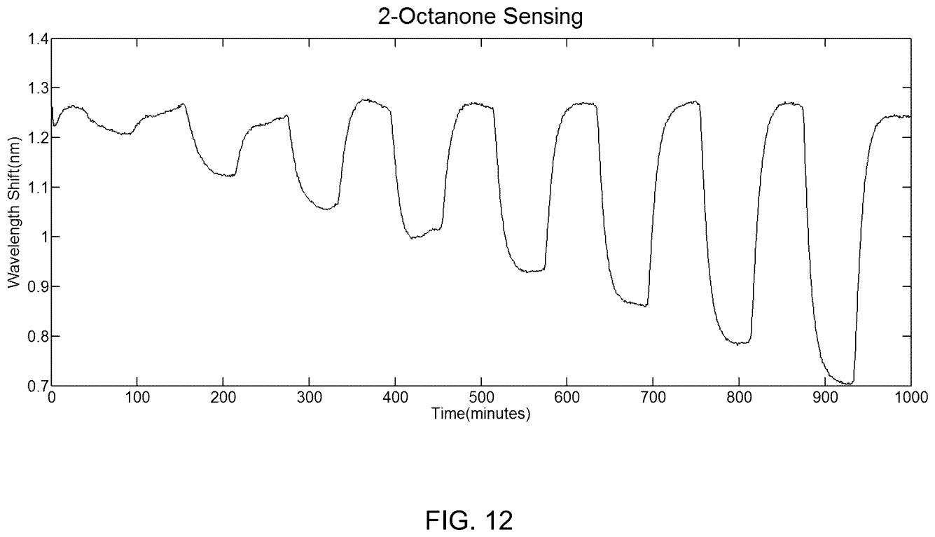

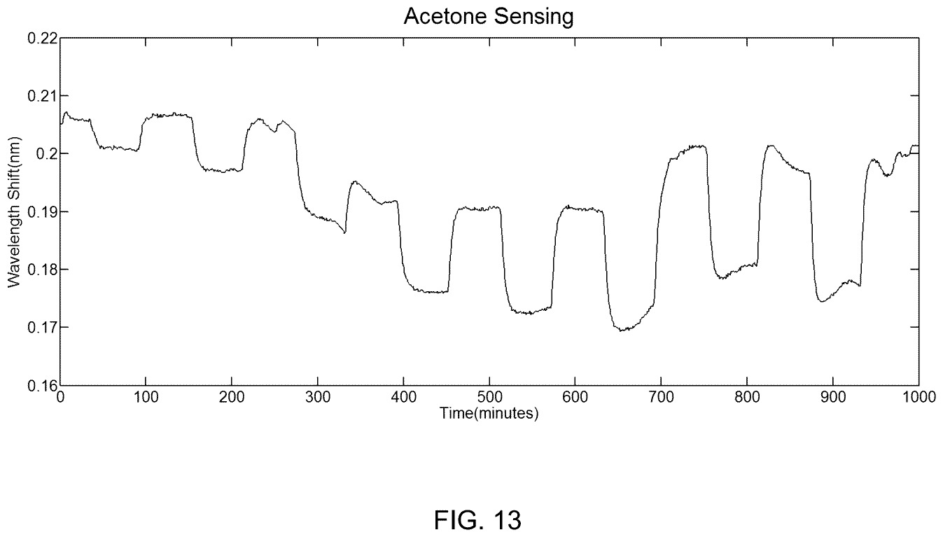

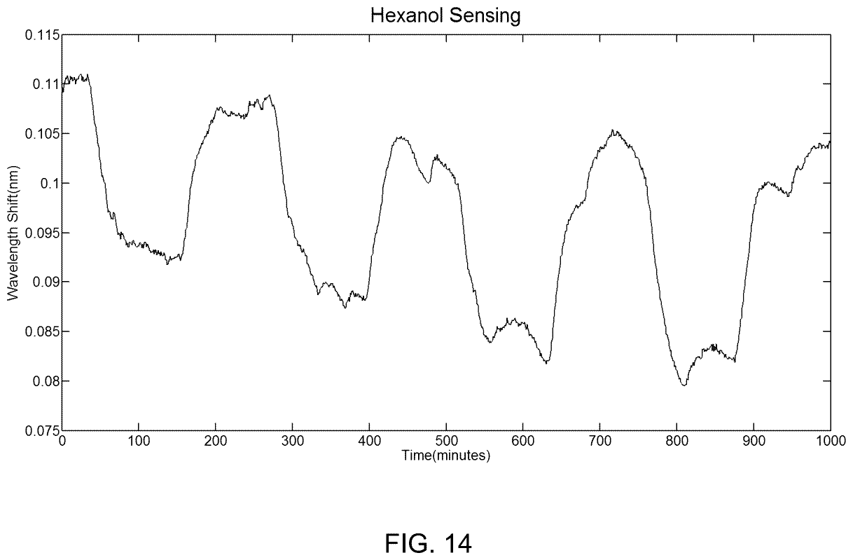

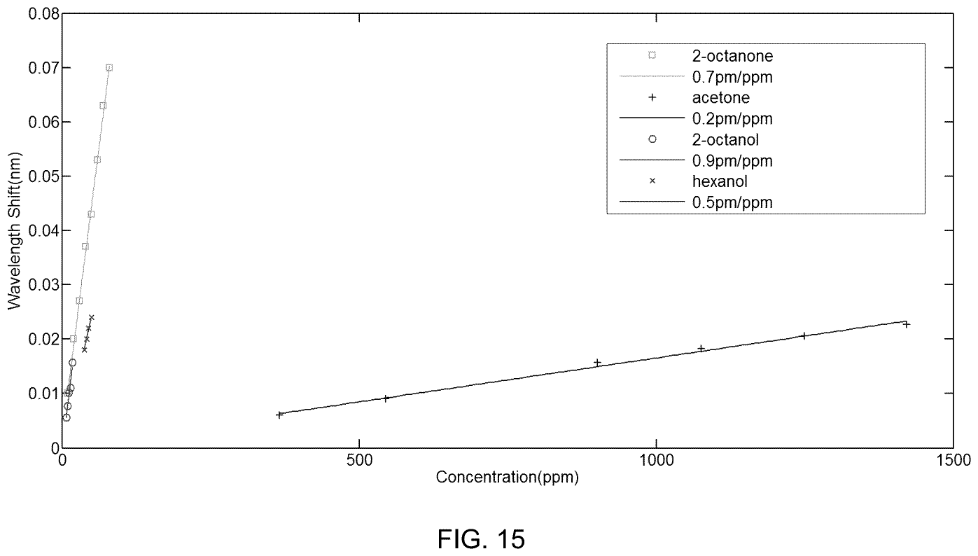

FIGS. 12-15 presents results that demonstrate the dynamic sensing performance and sensitivity of the example packaged WGM sensors to different gases. FIG. 12 graphs the detected wavelength shift as a function of time when detecting different concentrations of 2-octanone with the example packaged WGM gas sensors. FIG. 13 graphs the detected wavelength shift as a function of time when detecting different concentrations of acetone with the example packaged WGM gas sensors. FIG. 14 graphs the detected wavelength shift as a function of time when detecting different concentrations of hexanol with the example packaged WGM gas sensors. FIG. 15 graphs the measured wavelength shift as a function of concentration (in ppm) for the three gasses tested in FIGS. 12-14 using the example packaged WGM gas sensors.

In the experiment, a packaged microtoroid packaged in polymer was sealed in a gas chamber. Here the main material of the polymer is acrylic, which swells when exposed to gas, producing a blue shift as shown in FIG. 8 (dotted line). A different polymer may be selected as the packaging material depending on the type of gas desired to detect. The resonance shift response of a WGM in the packaged microtoroid to 2-ocatanone gas was first tested with a series of gassing/degassing cycles, starting at a minimum concentration of 10 parts per million (ppm), and increasing cycle by cycle. All gassing and degassing processes took about one hour. FIG. 12 shows 8 entire cycles (i.e., 8 one-hour gassing and 8 one-hour degassing cycles), and the concentration of 2-octanone gas in the gassing process of each cycle was 10 ppm larger than that of the previous cycle with a final concentration of 80 ppm. By fitting the wavelength shifts of the WGM for every concentration, the sensitivity of 0.7 pm/ppm for the detection of 2-octanone could be acquired, showing as the yellow fitting line in FIG. 15. Similar experiments were also performed for other types of gases, such as acetone and hexanol, as shown in FIGS. 13 and 14. For acetone, eight one-hour gas and eight one-hour degas cycles were performed and the concentration began at 360 ppm and increased by 180 ppm in each cycle, ending at 1590 ppm. For hexanol, four two-hour gas and four two-hour degas cycles were performed and the concentration began at 37 ppm and increased by about 4 ppm in each cycle, ending at 48 ppm (the last cycle increased by only 3 ppm). The sensitivities of different gases could be quite different, which was attributed to the different swelling degrees for different gases. In general, a gas possessing a small relative molecular mass swells the polymer less than a larger-molecule gas. For example, the sensitivity for the detection of acetone is about 0.2 pm/ppm, which is much smaller than that of the other larger-molecule gases. Therefore, the sensitivity provides information of the molecular mass of the gas sample, which may be used for the specific detection in some circumstances. To realize the biomolecular diagnostics, another sensing mechanism, i.e., absorption spectroscopy measurement, may be used and will be discussed below.

Selective gas sensing based on a packaged microtoroid resonator.

Many chemical species exhibit strong absorption spectra. The absorption lines or bands are specific to each species, and this forms the basis for their detection and measurement. Optical gas detection using absorption spectroscopy is based on the application of the Beer-Lambert Law, I=I₀exp(−αL), where I is the light transmitted through the gas cell, and I₀ is the light incident on the gas cell, and α is the absorption coefficient of the sample. The absorption coefficient, α, is the product of the gas concentration and the specific absorptivity of the gas. The Beer-Lambert Law does not inform whether or not a large gas chamber is needed for good sensitivity. Such a disadvantage may be avoided due to the high-quality (Q) factor and relatively long lifetime by applying micro-resonators. Exposing a gas to the packaged micro-resonator will introduce loss and cause mode broadening. By packaging the microtoroid, the mode shift and mode broadening schemes can be combined to gain more information. By monitoring the mode broadening selective gas sensing can be performed, and by monitoring mode shift, high sensitivity and a fast response are achieved.

While the resonance shift of WGMs provides sensitive indicators of the concentration of gases, the transmission spectra carry information of another dimension, i.e. optical absorption. Along the elongated optical path of the resonator, the extra absorption introduced by the gas sample is described by Beer-Lambert law, reading

$$I = {I}_{0} {e}^{- α L} \qquad ( 4 )$$

where I0 refers to the incident light intensity to the gas cell, with the external loss like coupling loss considered. The absorption coefficient, α, is the product of the gas concentration and the specific absorptivity of the gas. For a mixed sample, absorptions of different components are linearly combined as in αₜₒₜ=ΣCᵢαᵢ (Cᵢ: concentration of i^{th} component, αᵢ: absorption coefficient per unit). L is the effective optical length of the sensor cell, which is greatly enlarged due to the strong optical confinement of WGM resonators. In the transmission spectrum of a WGM resonator, the extra gas absorption is translated into a broadening of the resonant lineshape, following:

$$γ abs = \frac{{ω}_{m} r α}{m} \approx FSR \cdot r α \qquad ( 5 )$$

where m represents the azimuthal mode index, ωₘ is the angular frequency of the corresponding WGM, and r is the radius of the resonator. It should be noted that, in this work, we usually utilized only one family of WGMs with highest [symbol] . Within one band (usually <100 nm spanning), the dispersion of ωₘ could be neglected for visualizing the absorption signature, i.e., WGMs in the same family could be equidistant with a spacing of FSR and no zero offset. Thus, the broadening is approximately proportional to the absorption coefficient within a wavelength band, making it a direct indicator of the gas absorption. Thanks to the wide existence nature of WGM, the absorption spectrum of target gases could be acquired all over the transparent window of the materials of the sensor (silica, package polymer).

### Multi-Wavelength Information for Enhanced Specificity

The example embodiments described above mainly utilize the resonance response, e.g. linewidth broadening, of a polymer-coated resonator to extract absorption information of a target gas analyte. In certain applications, measurement accuracy may be affected by external factors, including nonspecific binding of unrelated molecules or particles, fluctuations in coupling conditions, and environmental influences such as humidity in gas sensing applications. These sources of interference can introduce noise or signals that are difficult to distinguish from those induced by the target analyte, potentially compromising the reliability and precision of the absorption data obtained.

To tackle these challenges and improve the robustness of measurements, in some embodiments, multiple laser sources operating at different wavelengths may be employed. Specifically, in these embodiments, multiple laser sources with distinct operating wavelengths are employed to probe the resonator either sequentially or simultaneously. By acquiring absorption information across a range of wavelengths, the spectral data, which contain information of the absorption profiles related to the atomic and molecular composition of the materials, can be analyzed to distinguish target-specific absorption from extraneous perturbations. In addition, this multi-wavelength approach can help to mitigate common-mode noise and compensate for environmental and system-induced variations, thereby improving the accuracy and reliability of the gas sensing system.

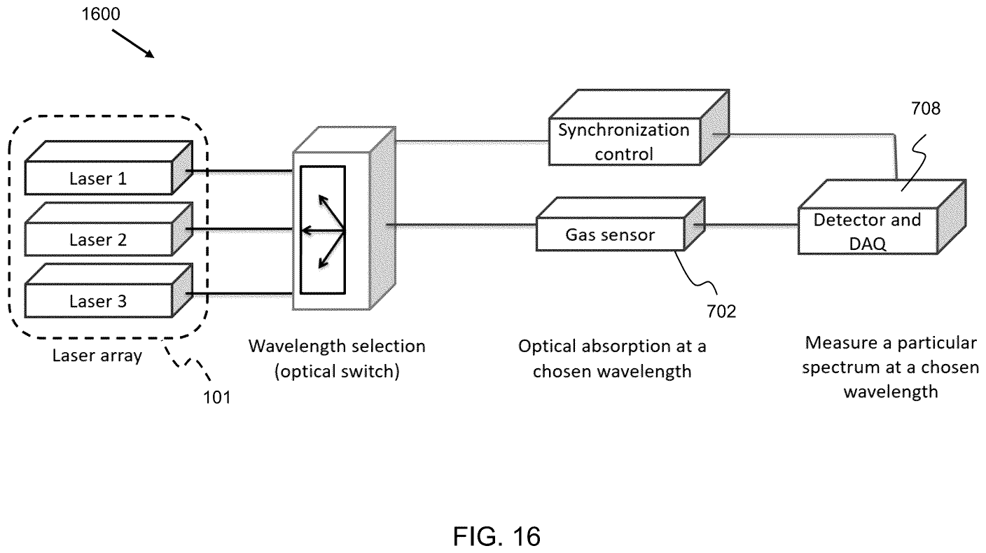

FIG. 16 is a schematic of an example sequential probing gas sensing system 1600. The system 1600 is similar to and based on the system 700. For simplicity, all of the details shown in FIG. 7 are not included, but it should be understood that additional components, such as the core module 710 will be needed and that other components may be changed, duplicated, modified, etc. For sequential probing, an array of tunable laser sources 101 with different wavelengths is time-multiplexed using synchronization control. This can be achieved through either an optical switch or a time-division multiplexing scheme, where each laser is activated to scan through the resonance in a predefined sequence. A synchronization unit ensures that each wavelength is applied at precise intervals, avoiding spectral overlap (cross-interference) and allowing separate extraction of the absorption characteristics. The wavelength selection and synchronization control may be part of the laser module 706 in some embodiments. A single photodetector 106 (not shown) in the receiver module 708 records the resonance response at each wavelength sequentially, with timing synchronization ensuring proper data alignment. High-speed analog-to-digital conversion (such as DAQ card) is used to capture potential resonance shifts and linewidth variations induced by the gas analyte.

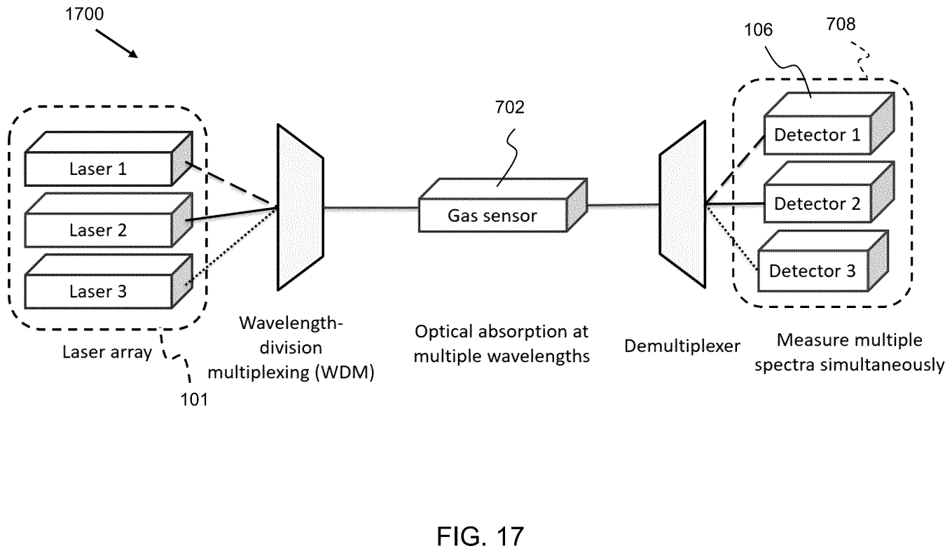

FIG. 17 is a schematic of an example simultaneous probing gas sensing system 1700. The system 1700 is similar to and based on the system 700. For simplicity, all of the details shown in FIG. 7 are not included, but it should be understood that additional components, such as the core module 710 will be needed and that other components may be changed, duplicated, modified, etc. For simultaneous probing, a wavelength-division multiplexing (WDM) system can be employed to launch multiple laser wavelengths into the resonator simultaneously. Optical components such as wavelength combiners (e.g., fiber Bragg gratings, dichroic mirrors, or an arrayed waveguide grating) can be used to merge multiple laser beams into a single optical path. This approach enables real-time spectral acquisition and minimizes measurement lag compared to sequential methods, but requires more careful design to ensure efficient coupling at different wavelengths. The output optical signal from the resonator is spectrally separated using a WDM demultiplexer, directing different wavelengths to separate photodetectors in the example embodiment. Alternatively, the output optical signal from the resonator may be analyzed by a spectrometer without demultiplexing and without needing separate photodetectors.

The collected spectral data undergoes computational analysis, where spectral analysis and machine learning algorithms are applied to differentiate between target-specific absorption features and background interferences. In this way, the multi-wavelength measurement method significantly improves the robustness of the sensor system by leveraging spectral information to eliminate common-mode noise and environmental drift, and thus improve the accuracy and repeatability of the gas sensor.

The demonstrated novel embodiments of gas sensing, as well as the packaged device, pave the way for next generation of gas sensors, such as atmospheric/environmental monitoring, pipeline leakage detection, explosive molecule testing, etc. The example gas sensing systems monitor both the real and imaginary parts of the refractive index of the analyte through mode shift and mode broadening possesses plenty of advantages over traditional optical gas sensors. First, high sensitivity down to ppb has been achieved thanks to the high energy confinement of WGMs. Second, the type of detected gas could be determined by measuring the absorption spectrum information of gas over a broad wavelength band via monitoring the mode linewidth of the resonant modes. On the other hand, the fabricated packaged micro-resonator device represents a major step towards the practicality. First, packaging both the micro-resonator and its tapered fiber coupler into the polymer isolates the mechanical perturbation, and thus makes the sensor robust and long-lived. Second, gas sensor array by packaging plenty of resonators with a single fiber could be achieved, which applies to multipoint gas monitoring, for example, pipeline leakage monitoring. Third, integrating with the fiber industry makes the proposed gas sensor extremely suitable for the long-distance gas monitoring, which makes it possible to separate the laser source and detector with sensor spatially, where the former is expensive and bulky, and the latter is cheap, tiny and easy to replace regularly. Looking forward, the packaged gas sensor together with proposed new sensing mechanism opens the path for the long-distance, high sensitivity and selectivity gas molecule detection.

This written description uses examples to disclose the invention, including the best mode, and also to enable any person skilled in the art to practice the invention, including making and using any devices or systems and performing any incorporated methods. The patentable scope is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

As used herein, the terms “about,” “substantially,” “essentially” and “approximately” when used in conjunction with ranges of dimensions, concentrations, temperatures or other physical or chemical properties or characteristics is meant to cover variations that may exist in the upper and/or lower limits of the ranges of the properties or characteristics, including, for example, variations resulting from rounding, measurement methodology or other statistical variation.

When introducing elements of the present disclosure or the embodiment(s) thereof, the articles “a”, “an”, “the” and “said” are intended to mean that there are one or more of the elements. The terms “comprising,” “including,” “containing” and “having” are intended to be inclusive and mean that there may be additional elements other than the listed elements. The use of terms indicating a particular orientation (e.g., “top”, “bottom”, “side”, etc.) is for convenience of description and does not require any particular orientation of the item described.

As various changes could be made in the above constructions and methods without departing from the scope of the disclosure, it is intended that all matter contained in the above description and shown in the accompanying drawing[s] shall be interpreted as illustrative and not in a limiting sense.

What is claimed is:

1. A gas sensing system comprising:
a packaged photonic sensor including a resonant sensor; and
a control system coupled to the packaged photonic sensor, the control system including:
a light module including a light source to generate light and transmit the generated light to the packaged photonic sensor;
a receiver module to receive light signals from the packaged photonic sensor and convert the received signals to digital signals; and
a core module including a computing device, the core module coupled to the light module and the receiver module, the core module programed to:
control the light module to cause the light module to generate and transmit light to the packaged photonic sensor;
receive the digital signals from the receiver module; and
detect one or both of a concentration of a gas that interacted with the resonant sensor and an identification of the gas whose molecules interacted with the resonant sensor based at least in part on the received digital signals from the receiver module.

2. The gas sensing system of claim 1, wherein the resonant sensor comprises a whispering gallery mode (WGM) resonator.

3. The gas sensing system of claim 2, wherein the packaged photonic sensor is adapted to be affected by a gas of interest.

4. The gas sensing system of claim 3, wherein the WGM resonator is encapsulated in a polymer affected by the gas of interest to adapt the packaged photonic sensor to be affected by the gas of interest.

5. The gas sensing system of claim 3, wherein the WGM resonator is coated in a polymer affected by the gas of interest to adapt the packaged photonic sensor to be affected by the gas of interest.

6. The gas sensing system of claim 5, wherein the WGM resonator is also encapsulated in the polymer affected by the gas of interest.

7. The gas sensing system of claim 1, wherein the light module is a laser module and the light source comprises a laser.

8. The gas sensing system of claim 7, wherein the laser module comprises a plurality of lasers and each laser of the plurality of laser is configured to operate at a different wavelength than each other laser of the plurality of lasers.

9. The gas sensing system of claim 8, further comprising a synchronization control device operable to time-multiplex the plurality of lasers sequentially.

10. The gas system of claim 8, wherein the receiver module comprises a plurality of detectors, a number of detectors in the plurality of detectors being a same as a number of lasers in the plurality of lasers, and wherein the light generated by the plurality of lasers is combined and the combined laser light is transmitted simultaneously to the packaged photonic sensor.

11. The gas system of claim 1, wherein the core module is programmed to detect a concentration of a gas that interacted with the resonant sensor based on a detected wavelength shift in the light coupled from the light module to the packaged photonic sensor.

12. The gas system of claim 1, wherein the core module is programmed to detect an identification of the gas whose molecules interacted with the resonant sensor based at least in part on a change in a resonant line shape of the light coupled from the light module to the packaged photonic sensor.

13. A packaged photonic sensor for detecting a gas of interest in a gas sensing system, the packaged photonic sensor comprising:
a whispering gallery mode (WGM) resonator;
a coupling waveguide positioned proximate the WGM resonator; and
a polymer that is affected by interaction with molecules of the gas of interest.

14. The packaged photonic sensor of claim 13, wherein the WGM resonator is encapsulated in the polymer.

15. The packaged photonic sensor of claim 13, wherein the polymer is a coating on the WGM resonator.

16. The packaged photonic sensor of claim 15, wherein the WGM resonator is also encapsulated in the polymer.

17. The packaged photonic sensor of claim 13, wherein the WGM resonator comprises a microtoroidal sensor.

18. A method of sensing gas comprising:
generating laser light and transmitting the laser light to a resonant sensor exposed to one or more gasses;
directing the laser light from the resonant sensor to a photodetector to create digital signals;
directing the digital signals from the photodetector to a computing device; and
detecting, by the computing device one or both of a concentration of a gas in the one or more gasses whose molecules interacted with the resonant sensor and an identification of a gas in the one or more gasses whose molecules interacted with the resonant sensor based at least in part on the digital signals from photodetector.

19. The method of claim 18, wherein detecting the concentration of the gas whose molecules interacted with the resonant sensor is based on a detected wavelength shift in the laser light.

20. The method of claim 18, wherein detecting an identification of the gas whose molecules interacted with the resonant sensor is based at least in part on a change in a resonant line shape of the laser light.
